(19) United States
(12) Patent Application Publication
(10) Pub. No.: US 2024/0304168 A1
(43) Pub. Date: Sep. 12, 2024

(54) NON-TRANSITORY COMPUTER-READABLE MEDIUM, TIMBRE SETTING DEVICE AND TIMBRE SETTING METHOD

(71) Applicant: Roland Corporation, Shizuoka (JP)

(72) Inventors: Kei ATSUMI, Hamamatsu (JP); Ayaka USUI, Hamamatsu (JP)

(73) Assignee: Roland Corporation, Shizuoka (JP)

(21) Appl. No.: 18/504,134

(22) Filed: Nov. 7, 2023

(30) Foreign Application Priority Data
Mar. 8, 2023 (JP) 2023-035510

(51) Int. Cl. G10H 1/02

(52) U.S. Cl. CPC G10H 1/02; G10H 2220/116

(57) ABSTRACT

A timbre setting program causes a computer equipped with a displayer to execute timbre setting processing for setting a timbre. The timbre setting program causes the computer to execute processing including: displaying, on the displayer, an appearance image that is an image of a target electronic device the timbre of which is simulated; displaying, on the displayer, a setting manipulator that sets a timbre parameter of the timbre; and displaying a correspondence display in which a correspondence is made between the setting manipulator and a manipulator displayed in the appearance image that performs the same setting as the setting manipulator.

### CROSS-REFERENCE TO RELATED APPLICATIONS

This application claims the priority benefit of Japan Application No. 2023-035510, filed on Mar. 8, 2023. The entirety of the above-mentioned patent application is hereby incorporated by reference herein and made a part of this specification.

### BACKGROUND

### Technical Field

The disclosure relates to a timbre setting program, a timbre setting device, and a timbre setting method.

### Related Art

As in Non-Patent Documents 1 and 2, there is software a timbre of which is simulated produced by an electronic device such as a synthesizer and sets the timbre. The software performs a display simulating the electronic device, and by operating a manipulator such as a knob or slider of the displayed electronic device, various timbre-related parameters (hereinafter referred to as “timbre parameters”) can be set.
Non-Patent Document 1: Vengeance Sound, Vengeance Producer Suite-Avenger, [online], [searched on Mar. 7, 2023], Internet <URL: https://www.vengeance-sound.com/plugins.php>
Non-Patent Document 2: Xfer Records, Serum Advanced Wavetable Synthesizer, [online], [searched on Mar. 7, 2023], Internet <URL: https://xferrecords.com/products/serum>

However, since a large number of manipulators are provided in the electronic device to be simulated, and the manipulators further vary in position in each electronic device, a user may experience a problem that it is difficult to grasp a position of a manipulator that sets a desired timbre parameter.

### SUMMARY

A non-transitory computer-readable medium of the disclosure records a timbre setting program that causes a computer equipped with a displayer to execute timbre setting processing for setting a timbre. The timbre setting program causes the computer to execute processing including: displaying, on the displayer, an appearance image that is an image of a target electronic device the timbre of which is simulated; displaying, on the displayer, a setting manipulator that sets a timbre parameter of the timbre; and displaying a correspondence display in which a correspondence is made between the setting manipulator and a manipulator displayed in the appearance image that performs the same setting as the setting manipulator.

A timbre setting device of the disclosure includes: an image display part, displaying an appearance image that is an image of a target electronic device a timbre of which is simulated; a manipulator display part, displaying a setting manipulator that sets a timbre parameter of the timbre; and a correspondence display part, displaying a correspondence display in which a correspondence is made between the setting manipulator and a manipulator displayed in the appearance image that performs the same setting as the setting manipulator.

A timbre setting method of the disclosure includes the following. An appearance image is displayed that is an image of a target electronic device a timbre of which is simulated. A setting manipulator is displayed that sets a timbre parameter of the timbre. A correspondence display is displayed in which a correspondence is made between the setting manipulator and a manipulator displayed in the appearance image that performs the same setting as the setting manipulator.

### BRIEF DESCRIPTION OF THE DRAWINGS

FIG. 1A is an external view of a personal computer (PC), and FIG. 1B illustrates a timbre setting screen.

FIG. 2A illustrates a waveform setting area, and FIG. 2B illustrates the timbre setting screen in a case where a display mode is an edit mode.

FIG. 3A is a functional block diagram of the PC, and FIG. 3B is a block diagram illustrating an electrical configuration of the PC.

FIG. 4A is a flowchart of main processing, and FIG. 4B is a flowchart of edit processing.

FIG. 5 is a flowchart of browse processing.

FIG. 6A illustrates the timbre setting screen in a modification, and FIG. 6B illustrates the timbre setting screen in another modification.

### DESCRIPTION OF THE EMBODIMENTS

The disclosure provides a timbre setting program, a timbre setting device and a timbre setting method which allow a user to easily grasp which manipulator is configured to set a desired timbre parameter in an appearance image of an electronic device that is simulated.

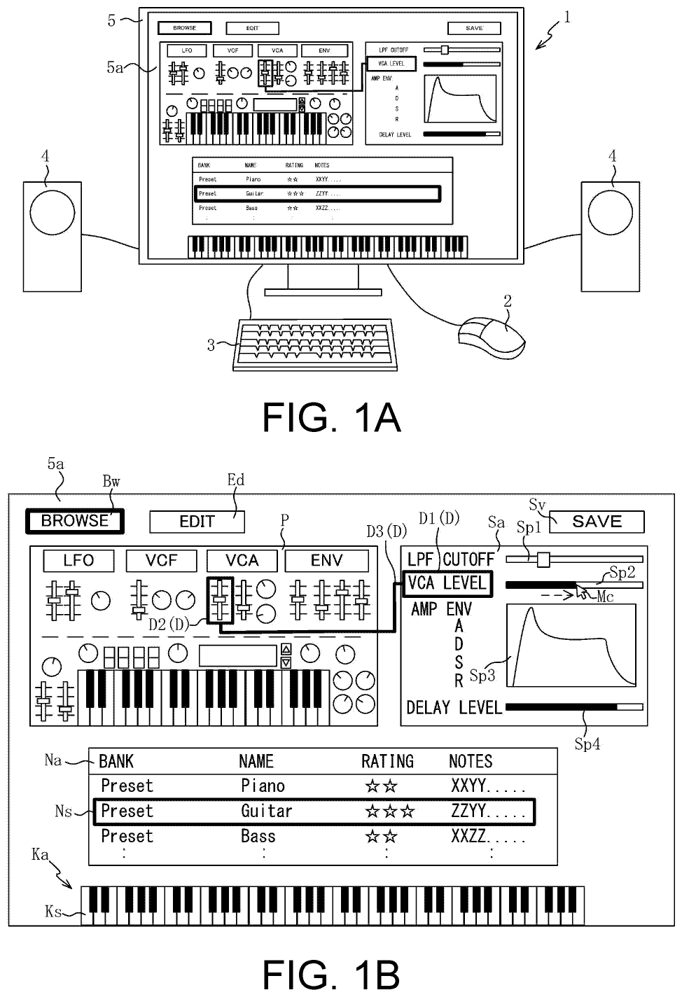

Hereinafter, embodiments will be described with reference to the accompanying drawings. An outline of a personal computer (PC) 1 of the present embodiment is described with reference to FIG. 1A and FIG. 1B. FIG. 1A is an external view of the PC 1. The PC 1 is an information processing device (computer) for setting a timbre and is used in outputting a musical sound in response to a performance operation by a user H or the like. The PC 1 is provided with a mouse 2 and a keyboard 3 that input an instruction from the user H, a speaker 4 that outputs sound, and a display device 5 that displays various setting screens or the like.

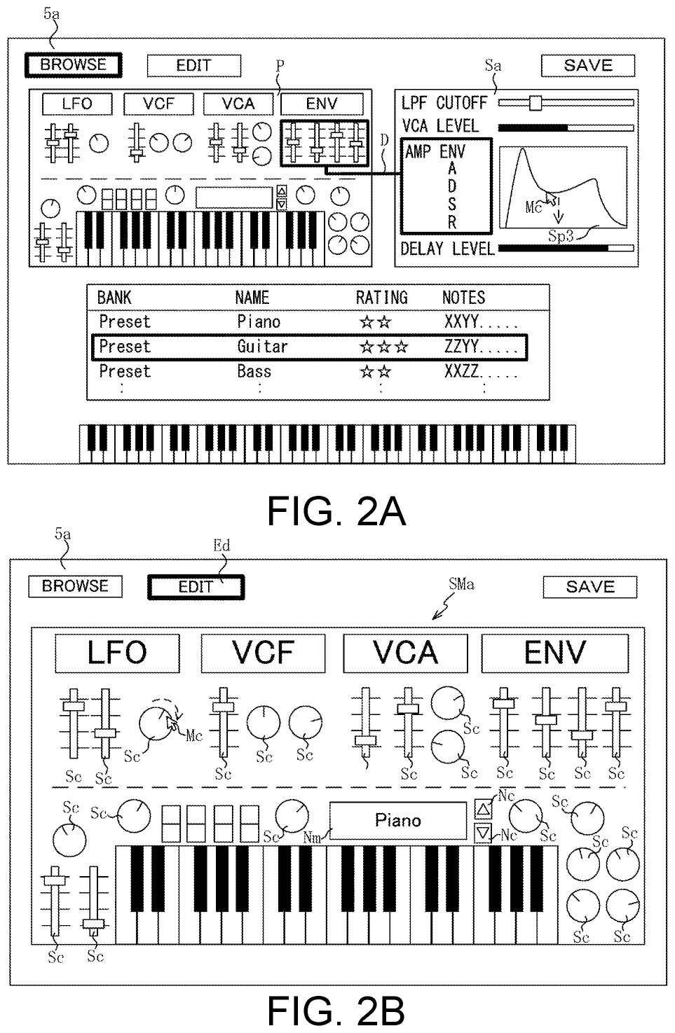

The display device 5 displays a timbre setting screen 5a being a screen for setting a timbre. On the timbre setting screen 5a, in response to the instruction from the user H from the mouse 2 and the keyboard 3, a timbre-related parameter (hereinafter referred to as “timbre parameter”) of an oscillator or a frequency filter or the like is set. The timbre setting screen 5a is described with reference to FIG. 1B to FIG. 2B.

FIG. 1B illustrates the timbre setting screen 5a. The timbre setting screen 5a displays a mouse cursor Mc, a browse button Bw, an edit button Ed, and a save button Sv that gives an instruction to overwrite and save a timbre parameter set on the timbre setting screen 5a, regardless of a display mode described later. The mouse cursor Mc is an arrow-shaped display part that moves on the timbre setting screen 5a in response to a movement operation of the mouse 2 performed by the user H.

The browse button Bw is a manipulator that switches the display mode of the PC 1 to a browse mode. The edit button Ed is a manipulator that switches the display mode of the PC 1 to an edit mode. The browse button Bw and the edit button Ed are configured so that either one may be selected.

In the present embodiment, as the display mode of the timbre setting screen 5a, there are provided the browse mode in which an appearance image P or a setting area Sa (both described later) is displayed on the timbre setting screen 5a and the edit mode in which an actual machine simulation area SMa (described later) is displayed on the timbre setting screen 5a. Of the browse button Bw and the edit button Ed, the display mode corresponding to the button specified by the user H via the mouse 2 is set, and a display according to the display mode is reflected on the timbre setting screen 5a. First, the browse mode is described.

The timbre setting screen 5a in the browse mode displays, in addition to the browse button Bw, the edit button Ed and the save button Sv mentioned above, the appearance image P, the setting area Sa, a timbre specification area Na, and a keyboard area Ka. For the appearance image P, displayed is an image of a target synthesizer (electronic device) a timbre of which is simulated. In setting of the timbre using the timbre setting screen 5a, a synthesizer the timbre of which is simulated is specified in advance, and various timbre parameters of the timbre installed in the synthesizer are set.

As the appearance image P, an image obtained by actually photographing the synthesizer that is simulated with a camera or the like is used. However, an image schematically depicting the synthesizer that is simulated or an image generated according to a three-dimensional model of the synthesizer may be used. In the present embodiment, a manipulator (hereinafter abbreviated as “manipulator of the appearance image P”) of the synthesizer displayed in the appearance image P is configured so that it cannot be operated via the mouse 2 or the like.

The setting area Sa is a display area where a setting manipulator being a manipulator for setting a timbre parameter is displayed. Specifically, displayed in the setting area Sa are: a setting manipulator Sp1 that sets a low-pass filter cutoff frequency, a setting manipulator Sp2 that sets the volume, a setting manipulator Sp3 that sets an amplifier envelope representing a temporal change in volume, and a setting manipulator Sp4 that sets a delay time.

Among them, a slider-type manipulator is used for the setting manipulators Sp1, Sp2, and Sp4. With the slider-type manipulator, a timbre parameter is set according to a position of a knob-like part of the manipulator (for example, the setting manipulator Sp1) or an end of a display representing a level of the manipulator (for example, the setting manipulator Sp2).

Specifically, by pointing the mouse cursor Mc to the knob-like part or the end of the display representing the level of the slider-type manipulator and directly dragging the mouse 2 rightward, the corresponding timbre parameter is increased; on the other hand, by dragging the mouse 2 leftward, the corresponding timbre parameter is decreased. By such a slider-type manipulator as the setting manipulators Sp1, Sp2, and Sp4, the user H is able to easily set an increase or decrease in the timbre parameter. The slider-type manipulator is not limited to being operated leftward or rightward, and may be operated upward or downward, or be operated in an oblique direction or other directions.

On the other hand, for the setting manipulator Sp3, a waveform setting area is used where a timbre parameter expressed by a waveform is set by being deformed by dragging with the mouse 2. The waveform setting area is herein described with reference to FIG. 2A.

FIG. 2A illustrates the waveform setting area. In the waveform setting area displayed as the setting manipulator Sp3, a waveform is displayed representing a temporal change in volume in the amplifier envelope. For the temporal change, four timbre parameters, namely, attack (A), decay (D), sustain(S), and release (R), are provided, and their respective values are set according to the shape of the waveform displayed in the waveform setting area.

The waveform displayed in the waveform setting area is configured to be deformable by dragging with the mouse 2. Specifically, in the waveform displayed in the waveform setting area, the user H points the mouse cursor Mc to a desired position and directly drags the mouse 2 (for example, downward). Thus, the position of the waveform specified by the mouse cursor Mc is moved in a direction (for example, downward) of the dragging, and the waveform is deformed accordingly. The four timbre parameters (attack, decay, sustain, and release) according to the shape of the deformed waveform are respectively reflected in the timbre parameters of the amplifier envelope. Accordingly, the amplifier envelope that requires setting of these four timbre parameters can be easily set by an intuitive operation such as dragging with the mouse 2.

In the setting area Sa, the setting manipulators Sp1 to Sp4 that set the same timbre parameters (namely, low-pass filter cutoff frequency, volume, amplifier envelope, and delay time) are displayed, regardless of the appearance image P in which the synthesizer the timbre of which is simulated is displayed. Accordingly, even if the user H switches the synthesizer the timbre of which is simulated, the same setting manipulators Sp1 to Sp4 are always displayed. Thus, the setting manipulators Sp1 to Sp4 that set the timbre parameters can be easily grasped, and the timbre parameters can be set without hesitation.

Each of the setting manipulators Sp1 to Sp4 does not necessarily set the timbre parameters mentioned above, and may set other timbre parameters. The setting area Sa is provided with four setting manipulators, namely, the setting manipulators Sp1 to Sp4. However, the disclosure is not limited thereto. The number of setting manipulators provided in the setting area Sa may be four or more or four or less.

Similarly to the setting manipulators Sp1 to Sp4 in the setting area Sa, the appearance image P also includes a manipulator of the synthesizer that is simulated. Thus, the user H may desire to grasp how the manipulator of the appearance image P corresponds to the setting manipulators Sp1 to Sp4. Accordingly, in the present embodiment, a correspondence display D is displayed in which a correspondence is made between the setting manipulators Sp1 to Sp4 and manipulators of the appearance image P that set the same timbre parameters as the setting manipulators Sp1 to Sp4. Referring again to FIG. 1B, the correspondence display D is described.

In FIG. 1B, the correspondence display D includes a first display D1, a second display D2, and a third display D3. The first display D1 displays a name of the setting manipulators Sp1 to Sp4 that perform setting in the setting area Sa by surrounding the name with a line. The second display D2 displays a manipulator of the appearance image P that sets the same timbre parameter as the setting manipulators Sp1 to Sp4 surrounded by the first display D1 by surrounding the manipulator of the appearance image P with a line. The third display D3 displays the first display D1 and the second display D2 by further connecting them with a line.

When any one of the setting manipulators Sp1 to Sp4 in the setting area Sa is specified by the user H by clicking the mouse 2, the first display D1 is displayed for the specified one of the setting manipulators Sp1 to Sp4, and the second display D2 is displayed for the manipulator (hereinafter referred to as “manipulator of the appearance image P corresponding to the setting manipulators Sp1 to Sp4”) of the appearance image P that sets the same timbre parameter as the specified one of the setting manipulators Sp1 to Sp4. Furthermore, the third display D3 is displayed which is a line connecting the first display D1 and the second display D2. Thus, a correspondence relation between the manipulator of appearance image P and the specified one of the setting manipulators Sp1 to Sp4 is clearly displayed.

Since a large number of manipulators are provided in the appearance image P, it is difficult for the user H to grasp which manipulator is configured to set which timbre parameter. Accordingly, by displaying the correspondence display D in which a correspondence is made between the specified setting manipulators Sp1 to Sp4 and their corresponding manipulators of the appearance image P, the user H is able to easily grasp the position of the manipulator that sets the timbre parameter desired to be set in the appearance image P.

The setting manipulators Sp1 to Sp4 in the setting area Sa are set to be larger in size than the manipulator of the appearance image P that sets the same timbre parameter. Accordingly, the operability regarding setting the timbre parameter can be improved, such as that the setting manipulators Sp1 to Sp4 can be easily specified by the mouse cursor M.

The timbre specification area Na is a display area where the timbre set in the setting area Sa is specified. In the timbre specification area Na, information regarding a timbre settable in the setting area Sa is displayed. Specifically, for each timbre, displayed are a bank (BANK) that is a region where the timbre is stored, a name (NAME) of the timbre, a rating (RATING) given to the timbre by the user H, and other notes (NOTES) of the user H regarding the timbre. In the timbre specification area Na, a timbre specified by the user H via the mouse 2 is displayed so as to be surrounded by a specification display Ns, and the timbre is taken as a target timbre to be set in the setting area Sa.

The keyboard area Ka is a display area for giving an instruction to produce a sound obtained by applying the timbre parameter set in the setting area Sa to the timbre specified in the timbre specification area Na. The keyboard area Ka is provided with a plurality of keys Ks. In the case where the key Ks is operated by the user H via the mouse 2, the sound obtained by applying the timbre parameter set in the setting area Sa to the timbre specified in the timbre specification area Na is produced. For a pitch of the sound produced at this time, a pitch corresponding to the operated key Ks is set.

By the keyboard area Ka like this, while setting a timbre parameter in the setting area Sa, the user H is able to perform trial listening of a sound based on the set timbre parameter. Thus, the timbre parameter can be efficiently set using the setting area Sa.

Next, with reference to FIG. 2B, the timbre setting screen 5a is described that is displayed in the case where the display mode is the edit mode. FIG. 2B illustrates the timbre setting screen 5a in the case where the display mode is the edit mode. In the case where the display mode is the edit mode, the timbre setting screen 5a displays, instead of the appearance image P, the setting area Sa, the timbre specification area Na, and the keyboard area Ka mentioned above, the actual machine simulation area SMa where the synthesizer the timbre of which is simulated is displayed.

In the actual machine simulation area SMa, an appearance image of the synthesizer the timbre of which is simulated is displayed similarly to the appearance image P. Similarly to the appearance image P, an image obtained by actually photographing the synthesizer that is simulated with a camera or the like or an image schematically depicting the synthesizer that is simulated may be used.

In the actual machine simulation area SMa, a manipulator Sc that sets a timbre parameter of the synthesizer included in the appearance image is configured to be operable. That is, each of the manipulators Sc displayed in the actual machine simulation area SMa is displayed in a manner (for example, slider position or knob angle) according to a setting state of the corresponding timbre parameter. Since the user H operates the manipulator Sc via the mouse 2, the setting state of the timbre parameter corresponding to the manipulator Sc is changed.

The actual machine simulation area SMa is provided with, in addition to the manipulator Sc of the synthesizer the timbre of which is simulated, a timbre display Nm that displays the target timbre to be set and a change manipulator Nc that switches the target timbre to be set. When the change manipulator Nc is operated, the target timbre to be set is switched in a predetermined order, the switched timbre is specified as the target timbre to be set, and its name is displayed in the timbre display Nm.

In the case where the display mode is switched from the browse mode to the edit mode, the timbre specified in the timbre specification area Na and the setting state of the timbre parameter set in the setting area Sa in the browse mode are directly reflected in the actual machine simulation area SMa in the edit mode. In contrast, in the case where the display mode is switched from the edit mode to the browse mode, the timbre and the setting state of the timbre parameter set in the actual machine simulation area SMa in the edit mode are directly reflected in the timbre specification area Na and the setting area Sa in the browse mode. Accordingly, continuous setting of the timbre parameters across display modes becomes possible.

In the browse mode mentioned above, while a timbre parameter can be easily set, the timbre parameter settable is limited to those corresponding to the setting manipulators Sp1 to Sp4, that is, low-pass filter cutoff frequency, volume, amplifier envelope, and delay time. Accordingly, by switching the display mode from the browse mode to the edit mode, it is possible to set a timbre parameter that can be set by the synthesizer the timbre of which is simulated and cannot be set in the browse mode.

In this way, on the timbre setting screen 5a, the timbre parameter can be flexibly set according to levels of proficiency of the user H or uses, such as that the user H who is a beginner not familiar with synthesizers can easily set the timbre parameter using the browse mode, and that the user H who is an advanced user rather familiar with synthesizers can set a wide variety of timbre parameters using the edit mode if necessary while also setting the timbre parameter using the browse mode.

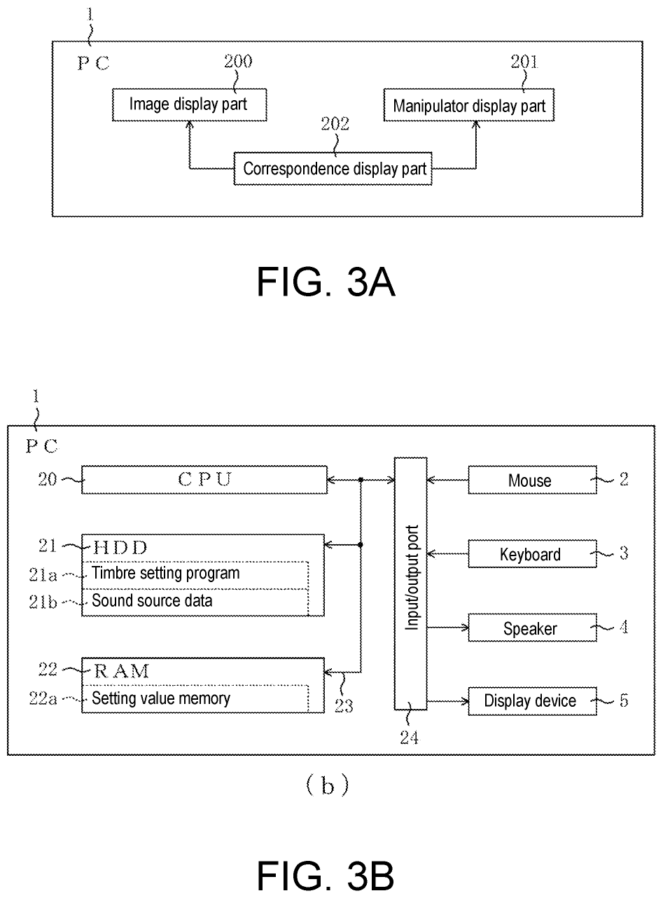

Next, a function of the PC 1 is described with reference to FIG. 3A. FIG. 3A is a functional block diagram of the PC 1. As illustrated in FIG. 3A, the PC 1 includes an image display part 200, a manipulator display part 201, and a correspondence display part 202.

The image display part 200 is a means of displaying the appearance image P that is an image of a target electronic device a timbre of which is simulated, and is realized by a CPU 20 described later in FIG. 3B. The manipulator display part 201 is a means of displaying the setting manipulators Sp1 to Sp4 that set the timbre parameter, and is realized by the CPU 20. The correspondence display part 202 is a means of displaying a correspondence display in which a correspondence is made between the setting manipulators Sp1 to Sp4 and the manipulator of the appearance image P that performs the same setting as the setting manipulators Sp1 to Sp4, and the correspondence display part 202 is realized by the CPU 20.

In the PC 1, the appearance image P is displayed, the setting manipulators Sp1 to Sp4 that set the timbre parameter are displayed, and the manipulator of the appearance image P that performs the same setting as the setting manipulators Sp1 to Sp4 is correspondingly displayed. Thus, the correspondence display clarifies the correspondence relation between the manipulator that sets the timbre parameter in the appearance image P and the setting manipulators Sp1 to Sp4. Accordingly, the user is able to easily grasp the position of the manipulator in the appearance image P that sets the timbre parameter desired to be set.

Next, an electrical configuration of the PC 1 is described with reference to FIG. 3B. FIG. 3B is a block diagram illustrating an electrical configuration of the PC 1. The PC 1 includes the CPU 20, a hard disk drive (HDD) 21, and a RAM 22 each of which is connected to an input/output (I/O) port 24 via a bus line 23. The mouse 2, the keyboard 3, the speaker 4, and the display device 5 mentioned above are further connected to the I/O port 24.

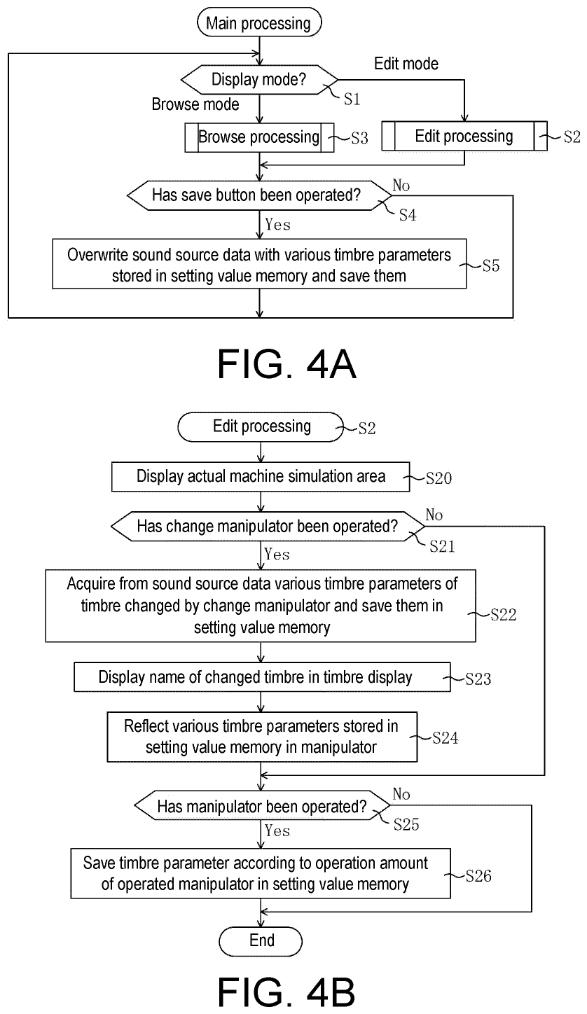

The CPU 20 is an arithmetic unit that controls each part connected by the bus line 23. The HDD 21 is a rewritable non-volatile storage device storing programs executed by the CPU 20 or fixed value data or the like, in which a timbre setting program 21a and sound source data 21b are stored. When the timbre setting program 21a is executed in the CPU 20, main processing of FIG. 4A is executed.

In the sound source data 21b, timbre-related information is stored. Specifically, in the sound source data 21b, stored for each synthesizer that is simulated are: various timbre parameters of each timbre; each display data of the appearance image P, the setting area Sa, the correspondence display D, the timbre specification area Na, the specification display Ns, and keyboard area Ka that are displayed in the case where the display mode is the browse mode; and the appearance image displayed in the case where the display mode is the edit mode. Display-related data such as the display data of the appearance image P or the correspondence display D is not necessarily stored in the sound source data 21b, and these data may also be stored in a different region from the sound source data 21b in the HDD 21.

The RAM 22 is a memory for rewritably storing various work data or flags or the like when the CPU 20 executes the timbre setting program 21a. The RAM 22 is provided with a setting value memory 22a in which a target timbre parameter to be set is stored.

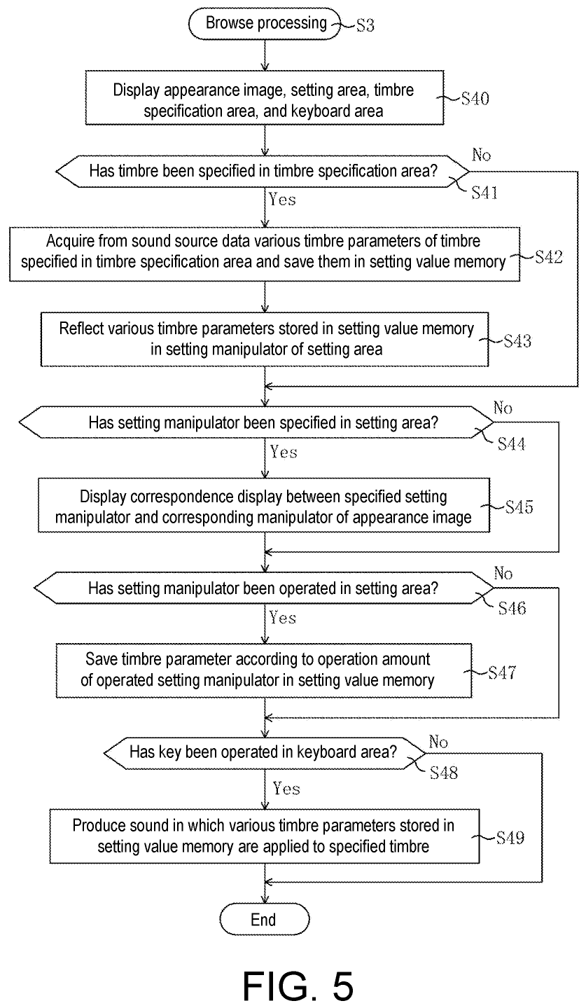

Next, the main processing executed by the CPU 20 of the PC 1 is described with reference to FIG. 4A, FIG. 4B and FIG. 5. FIG. 4A is a flowchart of the main processing. The main processing is processing executed in the case where the PC 1 is instructed to execute the timbre setting program 21a. In the main processing, first, it is confirmed whether either of the browse mode and the edit mode has been set as the display mode (S1).

In the processing of S1, if the edit mode has been set as the display mode (S1: “edit mode”), edit processing of S2 is executed; if the browse mode has been set as the display mode (S1: “browse mode”), browse processing of S3 is executed. Here, the edit processing of S2 and the browse processing of S3 are described with reference to FIG. 4B and FIG. 5.

FIG. 4B is a flowchart of the edit processing. In the edit processing, first, the actual machine simulation area SMa is displayed (S20). For an appearance image of a synthesizer displayed in the actual machine simulation area SMa, an image of a synthesizer specified in advance by the user H is acquired from the sound source data 21b and displayed.

After the processing of S20, it is confirmed whether the change manipulator Nc has been operated (S21). In the processing of S21, if it is confirmed that the change manipulator Nc has been operated (S21: Yes), various timbre parameters of a timbre changed by the operation of the change manipulator Nc are acquired from the sound source data 21b and saved in the setting value memory 22a (S22).

After the processing of S22, a name of the changed timbre is displayed in the timbre display Nm (S23). After the processing of S23, the various timbre parameters stored in the setting value memory 22a are respectively reflected in the manipulator Sc (S24). In the processing of S21, if it is not confirmed that the change manipulator Nc has been operated (S21: No), the processing of S22 to S24 is skipped.

After the processing of S21 and S24, it is confirmed whether the manipulator Sc has been operated (S25). In the processing of S25, if it is confirmed that the manipulator Sc has been operated (S25: Yes), a timbre parameter according to an operation amount of the operated manipulator Sc is saved in the setting value memory 22a (S26). On the other hand, in the processing of S25, if it is not confirmed that the manipulator Sc has been operated (S25: No), the processing of S26 is skipped. After the processing of S25 and S26, the edit processing is ended.

Next, the browse processing of S3 is described. FIG. 5 is a flowchart of the browse processing. In the browse processing, first, the appearance image P, the setting area Sa, the timbre specification area Na, and the keyboard area Ka are displayed (S40). Among them, for the appearance image P, an image of a synthesizer a timbre of which is simulated specified in advance by the user H is acquired from the sound source data 21b and displayed, and a timbre that can be set by the synthesizer is also acquired from the sound source data 21b and displayed in the timbre specification area Na.

After the processing of S40, it is confirmed whether the timbre has been changed in the timbre specification area Na (S41). In the processing of S41, if it is confirmed that the timbre has been changed in the timbre specification area Na (S41: Yes), various timbre parameters of the changed timbre are acquired from the sound source data 21b and saved in the setting value memory 22a (S42). After the processing of S42, the various timbre parameters stored in the setting value memory 22a are reflected in the setting manipulators Sp1 to Sp4 in the setting area Sa (S43). On the other hand, in the processing of S41, if it is not confirmed that the timbre has been changed in the timbre specification area Na (S41: No), the processing of S42 and S43 is skipped.

After the processing of S41 and S43, it is confirmed whether the setting manipulators Sp1 to Sp4 have been specified in the setting area Sa (S44). In the processing of S44, if it is confirmed that the setting manipulators Sp1 to Sp4 have been specified in the setting area Sa (S44: Yes), the correspondence display D between the specified setting manipulators Sp1 to Sp4 and the manipulator of the appearance image P corresponding to the setting manipulators Sp1 to Sp4 is displayed (S45).

Specifically, the display data of the first display D1, the second display D2 and the third display D3 corresponding to the specified setting manipulators Sp1 to Sp4 is acquired from the sound source data 21b, the first display D1 is displayed for the name of the specified setting manipulators Sp1 to Sp4, the second display D2 is displayed for the manipulator of the appearance image P corresponding to the setting manipulators Sp1 to Sp4, and the third display D3 is displayed in which the first display D1 and the second display D2 are connected with a line.

In the processing of S44, if it is not confirmed that the setting manipulators Sp1 to Sp4 have been specified in the setting area Sa (S44: No), the processing of S45 is skipped.

After the processing of S44 and S45, it is confirmed whether the setting manipulators Sp1 to Sp4 have been operated in the setting area Sa (S46). In the processing of S46, if it is confirmed that the setting manipulators Sp1 to Sp4 have been operated (S46: Yes), a timbre parameter according to an operation amount of the operated setting manipulators Sp1 to Sp4 is saved in the setting value memory 22a (S47). On the other hand, in the processing of S46, if it is not confirmed that the setting manipulators Sp1 to Sp4 have been operated (S46: No), the processing of S47 is skipped.

After the processing of S46 and S47, it is confirmed whether the key Ks has been operated in the keyboard area Ka (S48). In the processing of S48, if it is confirmed that the key Ks has been operated (S48: Yes), the speaker 4 produces a sound obtained by applying the various timbre parameters stored in the setting value memory 22a to the specified timbre (S49). For a pitch of the sound produced at this time, a pitch corresponding to the operated key Ks is set. On the other hand, in the processing of S48, if it is not confirmed that the key Ks has been operated (S48: No), the processing of S49 is skipped. After the processing of S48 and S49, the browse processing is ended.

Please refer back to FIG. 4A. After the edit processing of S2 or the browse processing of S3, it is confirmed whether the save button Sv has been operated (S4). In the processing of S4, if it is confirmed that the save button Sv has been operated (S4: Yes), the various timbre parameters in the sound source data 21b that are specified in the timbre specification area Na or the like are overwritten with the various timbre parameters stored in the setting value memory 22a and saved (S5). On the other hand, in the processing of S4, if it is not confirmed that the save button Sv has been operated (S4: No), the processing of S5 is skipped. After the processing of S4 and S5, the processing of S1 onward is repeated.

Although the disclosure has been described above based on the above embodiment, it can be easily inferred that various improvements or modifications may be made.

In the above embodiment, the correspondence display D is composed of the first display D1, the second display D2 and the third display D3. However, the disclosure is not limited thereto. For example, the correspondence display D may omit the first display D1 and the third display D3 and display only the second display D2, or the correspondence display D may omit the third display D3 and display only the first display D1 and the second display D2.

It is assumed that the first display D1 of the correspondence display D displays the name of the specified setting manipulators Sp1 to Sp4 by surrounding the name with a line. However, the disclosure is not limited thereto. In the first display D1, the specified setting manipulators Sp1 to Sp4 themselves may be surrounded, or the specified setting manipulators Sp1 to Sp4 and their names may be surrounded together.

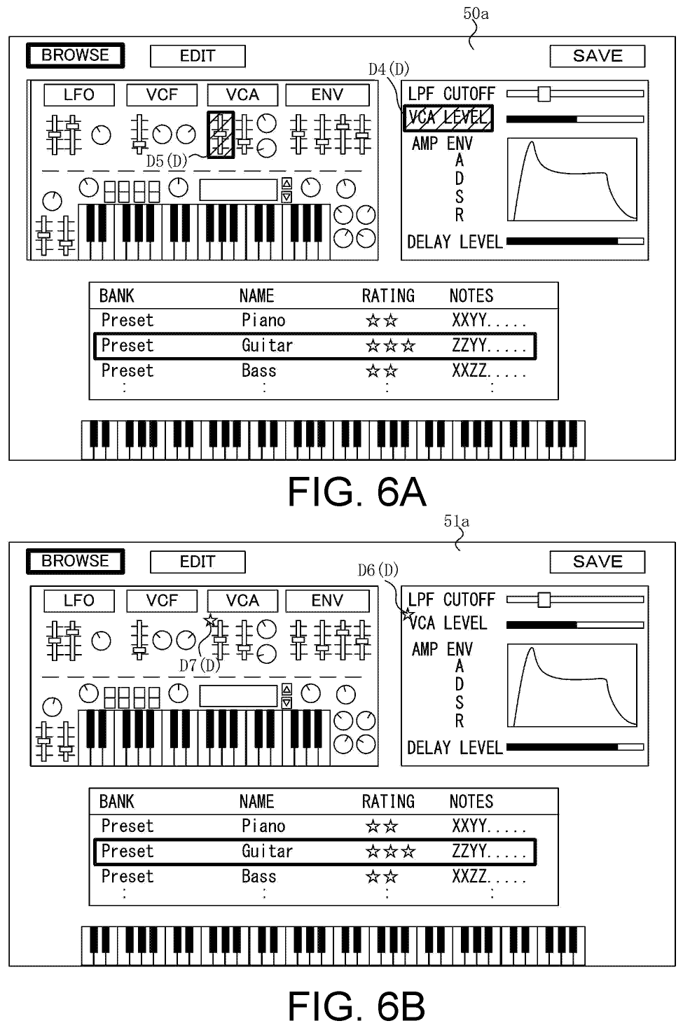

Alternatively, in the correspondence display D, it is not necessary that the name of the setting manipulators Sp1 to Sp4 and the manipulator of the appearance image P is surrounded by the first display D1 and the second display D2, and the first display D1 and the second display D2 are connected by the third display D3. For example, as on a timbre setting screen 50a of FIG. 6A, the correspondence display D may include a fourth display D4 and a fifth display D5. The fourth display D4 may be defined by hatching applied to the name of the setting manipulators Sp1 to Sp4. The fifth display D5 may be applied to the manipulator of the appearance image P corresponding to the setting manipulators Sp1 to Sp4, and may be defined by the same hatching as the fourth display D4.

By the fourth display D4 and the fifth display D5 that are defined by hatching in the same manner like this, the user H is able to easily grasp the position of the manipulator that sets the timbre parameter desired to be set in the appearance image P. The fourth display D4 and the fifth display D5 do not necessarily apply the same hatching. The fourth display D4 and the fifth display D5 may be applied with the same color, or the fourth display D4 and the fifth display D5 may be made to blink at the same timing such as by changing the brightness or luminance of regions surrounded respectively by the fourth display D4 and the fifth display D5 at the same timing.

As on a timbre setting screen 51a of FIG. 6B, the correspondence display D may include a sixth display D6 and a seventh display D7. The sixth display D6 may be defined by a star-shaped mark arranged near the setting manipulators Sp1 to Sp4. The seventh display D7 may be arranged near the manipulator of the appearance image P corresponding to the setting manipulators Sp1 to Sp4, and may be defined by the same star-shaped mark as the sixth display D6. The mark of the sixth display D6 and the seventh display D7 are not limited to the star shape, and other shapes such as a circle or a rectangle may be used.

In the case where the setting manipulators Sp1 to Sp4 are clicked with the mouse 2, the correspondence display D of the clicked setting manipulators Sp1 to Sp4 is displayed. However, the operation of displaying the correspondence display D is not limited thereto. For example, in the case where the mouse cursor Mc is located on the setting manipulators Sp1 to Sp4 or their names, the correspondence display D of the setting manipulators Sp1 to Sp4 located under the mouse cursor Mc may be displayed. In this case, the user H's operation of locating the mouse cursor Mc on the setting manipulators Sp1 to Sp4 or their names corresponds to specifying the setting manipulators Sp1 to Sp4 in the setting area Sa.

Alternatively, regardless of clicking of the mouse 2 or the mouse cursor Mc, all kinds of the correspondence display D may be displayed at all times, or the correspondence display D may be displayed in order (for example, correspondence display of the setting manipulator Sp1→correspondence display of the setting manipulator Sp2→ . . . ) every predetermined time (for example, 2 seconds), or the correspondence display D may be displayed in random order.

In the above embodiment, in the case where the display mode is the browse mode, the keyboard area Ka including the key Ks is provided. When the key Ks in the keyboard area Ka is operated, a sound obtained by applying a timbre parameter set in the setting area Sa to a timbre specified in the timbre specification area Na is produced. However, the disclosure is not limited thereto. For example, the sound obtained by applying the timbre parameter set in the setting area Sa to the timbre specified in the timbre specification area Na may be produced in the case where a MIDI controller including an input device such as a keyboard is connected to the PC 1 and a MIDI message is input from the MIDI controller. At this time, a pitch of the sound to be produced may be a pitch set in the input MIDI message.

In the above embodiment, in the case where the display mode is the browse mode, the slider-type manipulator among the setting manipulators Sp1 to Sp4 sets the timbre parameter by being dragged with the mouse 2. However, the disclosure is not limited thereto. For example, by pointing the mouse cursor Mc to a predetermined position of the slider-type manipulator and clicking the mouse 2, a timbre parameter corresponding to that position may be set. By pointing the mouse cursor Mc onto the slider-type manipulator and rotating a scroll wheel (not illustrated) provided on the mouse 2, the timbre parameter may be increased or decreased. In this case, when the scroll wheel is rotated upward, the timbre parameter may be increased; when the scroll wheel is rotated downward, the timbre parameter may be decreased. The timbre parameter may also be set by pointing the mouse cursor Mc to a desired position and operating a key such as an up key, a down key, a left key, and a right key on the keyboard 3 in that state.

Similarly, in the waveform setting area of the setting manipulators Sp1 to Sp4, a waveform is deformed by being dragged with the mouse cursor Mc and the timbre parameter is set according to the deformed waveform. However, the disclosure is not limited thereto. For example, in the waveform setting area, by pointing the mouse cursor Mc to a predetermined position and rotating the scroll wheel of the mouse 2, the position of the waveform to which the mouse cursor Mc is pointed may be moved up or down and the waveform may be deformed. In this case, when the scroll wheel is rotated upward, the position of the waveform to which the mouse cursor Mc is pointed may be moved upward; when the scroll wheel is rotated downward, the position of the waveform to which the mouse cursor Mc is pointed may be moved downward.

A waveform template being information regarding a preset shape of a waveform may have been displayed in the setting area Sa. The user H may drag and drop the waveform template having a desired waveform shape to the waveform setting area, thereby applying the waveform of the waveform template to the waveform setting area.

In the above embodiment, in the case where the display mode is the browse mode, a slider-type manipulator such as the setting manipulator Sp1 or a waveform setting area such as the setting manipulator Sp3 is described as an example of the setting manipulator. However, embodiments of the setting manipulator are not limited thereto, and other embodiments of manipulators such as a knob-type manipulator may be used. An input area where the user H directly inputs a numerical value of a timbre parameter via the mouse 2 or the keyboard 3 may serve as the setting manipulator.

In the above embodiment, in the case where the display mode is the browse mode, the manipulator of the appearance image P is configured to be inoperable. However, the disclosure is not limited thereto. For example, similarly to the actual machine simulation area SMa in the case where the display mode is the edit mode, the manipulator of the appearance image P may be configured to be operable. At this time, the timbre parameter changed by operating the manipulator of the appearance image P may be reflected in the corresponding setting manipulators Sp1 to Sp4 in the setting area Sa.

In the above embodiment, the same setting manipulators Sp1 to Sp4 are displayed in the setting area Sa regardless of the appearance image P. However, the disclosure is not limited thereto. The setting manipulators Sp1 to Sp4 may be displayed according to the appearance image P. For example, if a synthesizer without delay time setting is displayed in the appearance image P in order to be simulated, the setting manipulator Sp4 may be omitted from being displayed.

In setting of a timbre parameter when the display mode is the edit mode, a timbre parameter frequently changed by the manipulator Sc may be extracted in advance. Subsequently, when the display mode is the browse mode, a target timbre parameter to be set by the setting manipulators Sp1 to Sp4 may be the timbre parameter frequently changed that is extracted in the edit mode. Accordingly, since the setting area Sa displays the setting manipulators Sp1 to Sp4 that take the timbre parameter frequently set by the user H as a setting target, the setting area Sa can be made easy to use for the user H.

Furthermore, the setting manipulators Sp1 to Sp4 may be arranged in order from the timbre parameter that is frequently changed. For example, a setting manipulator that sets the most frequently changed timbre parameter may be arranged to be the setting manipulator Sp1, and a setting manipulator that sets the second frequently changed timbre parameter may be arranged to be the setting manipulator Sp2. Similarly, the setting manipulators that set the third and fourth frequently changed timbre parameters may be arranged to be the setting manipulators Sp3 and Sp4, respectively.

In the edit processing of FIG. 4B, in addition to the processing of S21 to S24 for the operation of the change manipulator Nc and the processing of S25 and S26 for the operation of the manipulator Sc, as in the processing of S48 and S49 of the browse processing of FIG. 5, sound production may be performed based on an operation of the keyboard (see FIG. 2B) in the appearance image in the actual machine simulation area SMa.

In the above embodiment, in the processing of S5 of the main processing of FIG. 4A, in the case where the save button Sv is operated, various timbre parameters of the timbre specified in the timbre specification area Na or the like in the sound source data 21b are overwritten and saved with various timbre parameters stored in the setting value memory 22a. However, the disclosure is not limited thereto. For example, in the case where the save button Sv is operated, those in the sound source data 21b obtained by applying various timbre parameters stored in the setting value memory 22a to the timbre specified in the timbre specification area Na or the like may be stored as a separate timbre in the sound source data 21b. In the case where the save button Sv is operated, it is possible to select whether to overwrite or save a timbre or save the same as a different timbre.

In the above embodiment, the PC 1 is used as an example of the computer that executes the timbre setting program 21a. However, the disclosure is not limited thereto. The timbre setting program 21a may be executed by an information processing device such as a smartphone or a tablet terminal, an electronic musical instrument, or other electronic devices. In this case, instead of the mouse 2 and the keyboard 3, a touch panel may be provided over the display device 5. The disclosure may be applied to a dedicated device (timbre setting device) that stores the timbre setting program 21a in a ROM or the like and executes only the timbre setting program 21a.

What is claimed is:

1. A non-transitory computer-readable medium recording a timbre setting program that causes a computer equipped with a displayer to execute timbre setting processing for setting a timbre, wherein the timbre setting program causes the computer to execute processing comprising:
displaying, on the displayer, an appearance image that is an image of a target electronic device the timbre of which is simulated;
displaying, on the displayer, a setting manipulator that sets a timbre parameter of the timbre; and
displaying a correspondence display in which a correspondence is made between the setting manipulator and a manipulator displayed in the appearance image that performs same setting as the setting manipulator.

2. The non-transitory computer-readable medium according to claim 1, wherein,
in displaying the appearance image, the appearance image according to the target electronic device the timbre of which is simulated is displayed; and
in displaying the setting manipulator, a setting manipulator in a common manner is displayed regardless of a manner of the appearance image displayed.

3. The non-transitory computer-readable medium according to claim 1, wherein the computer is equipped with an input unit that inputs an operation by a user;
the timbre setting program causes the computer to further execute processing comprising acquiring, in the setting manipulator, a setting manipulator specified by the user via the input unit; and
in displaying the correspondence display, a correspondence display is displayed in which a correspondence is made between the setting manipulator acquired and the manipulator of the appearance image that performs the same setting as the setting manipulator.

4. The non-transitory computer-readable medium according to claim 1, wherein,
in displaying the correspondence display, a display connecting the setting manipulator and the manipulator of the appearance image that performs the same setting as the setting manipulator with a line is displayed as a correspondence display.

5. The non-transitory computer-readable medium according to claim 1, wherein
the computer is equipped with an input unit that inputs an operation by a user; and
in displaying the setting manipulator, a slider-type manipulator that increases or decreases the timbre parameter in response to the operation by the user that is input via the input unit is displayed as a setting manipulator.

6. The non-transitory computer-readable medium according to claim 1, wherein
the computer is equipped with an input unit that inputs an operation by a user;
the timbre parameter is set according to a shape of a waveform; and
in displaying the setting manipulator, a waveform setting area is displayed as a setting manipulator where, by deforming the shape of the waveform corresponding to the setting of the timbre parameter in response to the operation by the user that is input via the input unit, a timbre parameter according to the waveform deformed in shape is acquired.

7. The non-transitory computer-readable medium according to claim 1, wherein the timbre setting program causes the computer to further execute processing comprising trial listening in which a timbre is produced to which the timbre parameter set by the setting manipulator is applied.

8. A timbre setting device, comprising:
an image display part, displaying an appearance image that is an image of a target electronic device a timbre of which is simulated;
a manipulator display part, displaying a setting manipulator that sets a timbre parameter of the timbre; and
a correspondence display part, displaying a correspondence display in which a correspondence is made between the setting manipulator and a manipulator displayed in the appearance image that performs same setting as the setting manipulator.

9. The timbre setting device according to claim 8, wherein
the image display part further displays the appearance image according to the target electronic device the timbre of which is simulated; and
the manipulator display part further displays a setting manipulator in a common manner regardless of a manner of the appearance image displayed by the image display part.

10. The timbre setting device according to claim 8, further comprising:
an input unit, inputting an operation by a user, wherein
a setting manipulator specified by the user via the input unit is acquired in the setting manipulator; and
the correspondence display part further displays a correspondence display in which a correspondence is made between the setting manipulator acquired and the manipulator of the appearance image that performs the same setting as the setting manipulator.

11. The timbre setting device according to claim 8, wherein
the correspondence display part further displays, as a correspondence display, a display connecting the setting manipulator and the manipulator of the appearance image that performs the same setting as the setting manipulator with a line.

12. The timbre setting device according to claim 8, further comprising:
an input unit, inputting an operation by a user, wherein
the manipulator display part displays, as a setting manipulator, a slider-type manipulator that increases or decreases the timbre parameter in response to the operation by the user that is input via the input unit.

13. The timbre setting device according to claim 8, further comprising:
an input unit, inputting an operation by a user, wherein
the timbre parameter is set according to a shape of a waveform; and
the manipulator display part displays, as a setting manipulator, a waveform setting area where, by deforming the shape of the waveform corresponding to the setting of the timbre parameter in response to the operation by the user that is input via the input unit, a timbre parameter according to the waveform deformed in shape is acquired.

14. The timbre setting device according to claim 8, wherein
trial listening is performed in which a timbre is produced to which the timbre parameter set by the setting manipulator is applied.

15. A timbre setting method, comprising:
displaying an appearance image that is an image of a target electronic device a timbre of which is simulated;
displaying a setting manipulator that sets a timbre parameter of the timbre; and
displaying a correspondence display in which a correspondence is made between the setting manipulator and a manipulator displayed in the appearance image that performs same setting as the setting manipulator.

16. The timbre setting method according to claim 15, wherein,
in displaying the appearance image, the appearance image according to the target electronic device the timbre of which is simulated is displayed; and
in displaying the setting manipulator, a setting manipulator in a common manner is displayed regardless of a manner of the appearance image displayed.

17. The timbre setting method according to claim 15, further comprising:
acquiring, in the setting manipulator, a setting manipulator specified by a user; and
in displaying the correspondence display, a correspondence display is displayed in which a correspondence is made between the setting manipulator acquired and the manipulator of the appearance image that performs the same setting as the setting manipulator.

18. The timbre setting method according to claim 15, wherein,
in displaying the correspondence display, a display connecting the setting manipulator and the manipulator of the appearance image that performs the same setting as the setting manipulator with a line is displayed as a correspondence display.

19. The timbre setting method according to claim 15, wherein
in displaying the setting manipulator, a slider-type manipulator that increases or decreases the timbre parameter in response to an input operation by a user is displayed as a setting manipulator.

20. The timbre setting method according to claim 15, wherein
the timbre parameter is set according to a shape of a waveform; and
in displaying the setting manipulator, a waveform setting area is displayed as a setting manipulator where, by deforming the shape of the waveform corresponding to the setting of the timbre parameter in response to an input operation by a user, a timbre parameter according to the waveform deformed in shape is acquired.
